(19) United States
(12) Patent Application Publication
(10) Pub. No.: US 2010/0303603 A1
(43) Pub. Date: Dec. 2, 2010

(54) Portable Adjustable Height Platform

(76) Inventors: James Galante, Falmouth, ME (US); Ian MacLeod, Saco, ME (US); Stephen Hasty, Parsonsfield, ME (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 12/792,172

(22) Filed: Jun. 2, 2010

Related U.S. Application Data
(60) Provisional application No. 61/183,293, filed on Jun. 2, 2009.

(51) Int. Cl. B62B 3/02; F16M 11/00; F16M 11/24; B65B 69/00

(52) U.S. Cl. 414/811; 248/161; 248/162.1; 280/35

(57) ABSTRACT

A system and method for stocking and/or restocking shelves. The system includes a support member and a top platform coupled to the support member. The top platform is configured to receive at least one of a container of product and individual items to be at least one of stocked and restocked. The system includes a base portion coupled to the support member, wherein the base portion is configured to facilitate positioning the system relative to a shelf to be at least one of stocked or restocked. A height of the top platform is configured to be adjusted to a user-selected height and fixed at the user-selected height prior to receiving the at least one of the container of product and the individual items.

### CROSS-REFERENCE TO RELATED APPLICATIONS

This application claims the benefit of U.S. provisional patent application Ser. No. 61/183,293, filed Jun. 2, 2009, the entire disclosure of which is incorporated herein by reference.

### FIELD

The present disclosure relates in general to a portable adjustable height platform configured for assisting stocking shelves.

### BACKGROUND

Typically, when stocking and restocking store, e.g., grocery store, shelves, a worker may utilize a wheeled cart to move product from storage to the shelf for stocking. The product may be packaged in bulk, for example, in containers such as boxes. The wheeled cart may be a “pallet truck” configured to carry a pallet of containers or may include a fixed height platform configured to carry containers of product. In both, the containers may be positioned relatively close to the ground to provide stability when moving the containers a distance. The worker may then lift and hold a container of product or some number of items from a container, for placing on the shelf. Because store shelving is generally multi-tiered, the worker is required to hold the container or loose product at varying heights, for placement on the store shelf. Holding a container and/or loose product at varying heights can be awkward and tiring.

### BRIEF DESCRIPTION OF THE DRAWINGS

For a better understanding of the present invention, together with other objects, features and advantages, reference should be made to the following detailed description which should be read in conjunction with the accompanying figures, wherein:

FIG. 1A is a sketch of one embodiment of a portable adjustable height platform system consistent with the present disclosure;

FIG. 1B is a front view of a the portable adjustable height platform system of FIG. 1A, illustrating two heights of the top platform;

FIG. 1C is a bottom view of a base portion of a portable adjustable height platform system of FIG. 1A;

FIG. 2 is a sketch of a side view of the portable adjustable height platform system of FIG. 1A;

FIG. 3A is a bottom view of an embodiment of a top platform of a portable adjustable height system consistent with the present disclosure;

FIG. 3B is a side sectional view of the top platform of FIG. 3A;

FIG. 4A is a sketch of another embodiment of a portable adjustable height platform system consistent with the present disclosure;

FIG. 4B s a sketch of a side view of the portable adjustable height platform system of FIG. 4A;

FIGS. 5A through 5C are sketches of one embodiment of a counter balance system, including a counter weight, for a portable adjustable height platform system consistent with the present disclosure; and

FIG. 6 is a flow chart for stocking and/or restocking shelves using a portable adjustable height platform consistent with the present disclosure.

### DETAILED DESCRIPTION

Generally, the present disclosure relates to a portable adjustable height platform system and method configured to facilitate stocking and/or restocking shelves in a store. The store may be a grocery store, supermarket, box store and/or other types of stores where goods and/or products may be removed from shelves by, e.g., customers, and may be placed on shelves by workers. The goods and/or products may be removed from and replaced on the shelves by the workers. The shelves may be multi-tiered, i.e., may include a plurality of individual shelves positioned at varying heights.

The system may include a top platform coupled to a base portion by a support member. The top platform is configured to receive a container, such as a box, of product and/or individual items to be stocked and/or restocked. The system may include a base portion coupled to the support member. The base portion is configured to facilitate positioning the system relative to a shelf to be stocked and/or restocked. A height of the top platform is configured to be adjusted to a user-selected height and fixed at the user-selected height prior to receiving the container of product and/or the individual items.

The system may further include a counter balance configured to counter a weight associated with the top platform so that the height of the top platform may be adjusted with relatively small effort. The system may further include one or more fixing members configured to engage the support member to hold the top platform at the user-selected height. The counter balance is configured to present the top platform in a neutral condition so that the top platform does not rise or fall rapidly when the fixing member(s) are disengaged from the support member. The system may further include a locking pin to further “lock” the top platform at the user-selected height.

The base portion may include a plurality of wheels, e.g., four, configured to allow movement of the system between a supply of products and the shelf(ves) that are to be stocked and/or restocked. As used herein, “stocking” includes activities related to placing product on shelves and may also include removing product from shelves.

For example, a shelf may be stocked and/or restocked with product from a container of product and/or individual items. In this example, the top platform may be adjusted to a user-selected height and the container and/or individual items may be placed on the top platform, from, e.g., a supply of product. The portable adjustable height platform system may then be moved to the shelf and the shelf may be stocked and/or restocked.

In another example, a portable adjustable height platform system consistent with the present disclosure, may be used to facilitate rotating stock. For example, it may be desirable to rotate dated and/or perishable product. Dated and/or perishable product may include, but not be limited to, dairy products, including yogurt, milk, etc., other food products, and/or pharmaceuticals. In this example, the top platform may be adjusted to a user-selected height and a container of “newer” product and/or individual “newer” items may be placed on the top platform. The portable adjustable height platform system may then be moved adjacent a shelf containing the product to be rotated, e.g., “older” product. The older product may then be moved from the shelf to the top platform and the new product may be placed on the shelf, e.g., in a back region of the shelf. The older product may then be returned to the shelf in front of the newer product. In this manner, the portable adjustable height platform system may facilitate rotating stock.

In another example, a portable adjustable height platform system consistent with the present disclosure, may be used to facilitate repricing stock. For example, it may be desirable to reprice product for a sale and/or after a sale. In this example, the top platform may be adjusted to a user-selected height. The portable adjustable height platform system may then be moved adjacent a shelf containing the product to be repriced. The product may then be moved from the shelf to the top platform, repriced and then returned to the shelf. In this manner, the portable adjustable height platform system may facilitate repricing stock.

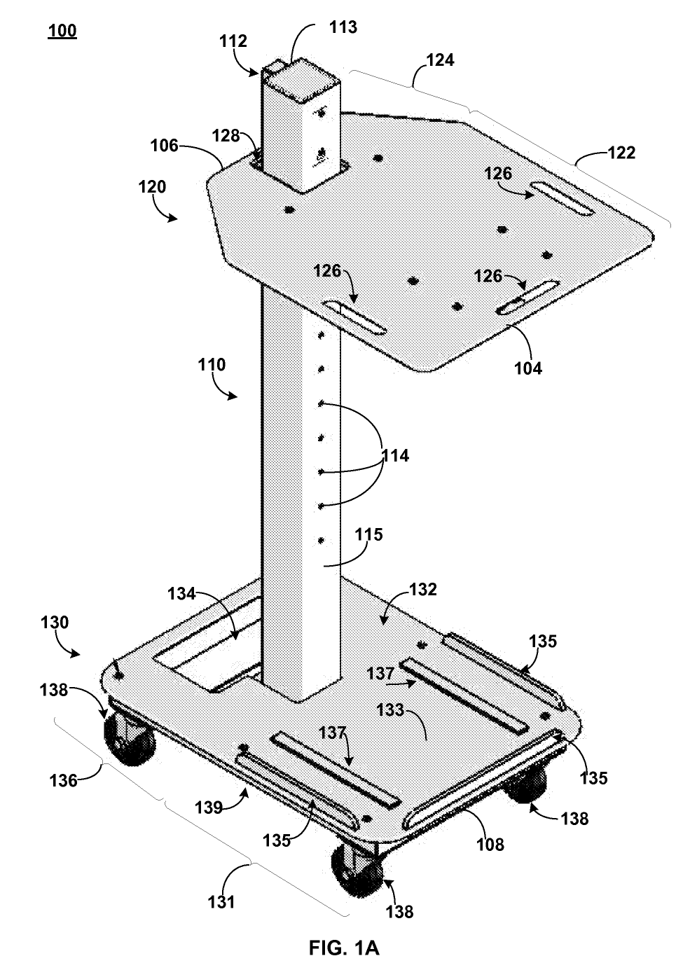

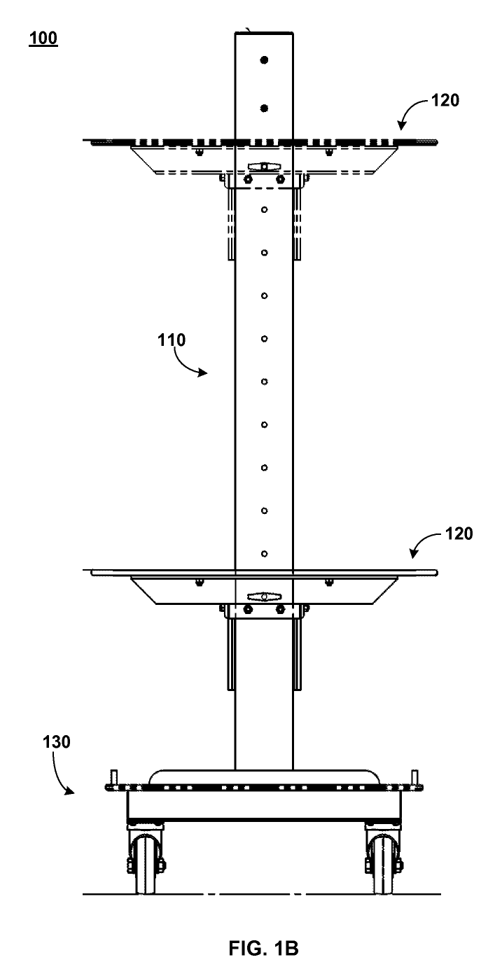

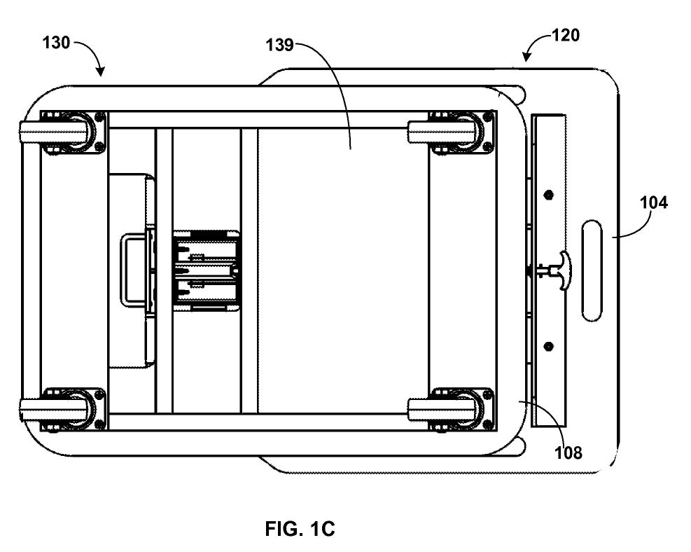

Turning to FIG. 1A, there is illustrated a sketch of an exemplary embodiment of a portable adjustable height platform system 100 consistent with the present disclosure. The system 100 includes a support member 110 coupled to a top platform 120 and coupled to a base portion 130. The support member 110 is configured to support the top platform 120 at a plurality of user-selected heights above the base portion 130.

The top platform 120 is configured to receive a container product and/or a plurality of items for stocking and/or restocking a shelf and/or rotating stock. The top platform 120 may be constructed of, e.g., high density polyethylene, and/or another material suitable for contact with food, e.g., stainless steel, as will be understood by those skilled in the art. The top platform 120 may be substantially flat. The top platform 120 may include a front portion 122 and a back portion 124. “Front” and “back”, as used herein, are meant only to differentiate portions of the top platform 120 and are not meant to limit a position of the system 100, a position of a worker relative to the system 100, and/or a position of the system relative to a shelf. The top platform 120 may include a front edge 104 and a back edge 106.

For example, the top platform 120 may be about 24 inches wide by about 28 inches long. The front portion 122 may be substantially rectangular, with generally rounded corners. Although the front portion 122 is described as substantially rectangular, the front portion 122 is not limited to a substantially rectangular shape and other shapes may be utilized, within the scope of the present disclosure. For example, the front portion 122 may be about 24 inches wide by about 22 inches long (front to back), i.e., the back portion 124 may be about 6 inches long. The front portion 122 of the top platform 120 may define one or more openings 126, configured to provide hand holds for a user of the system 100. The handholds 126 may be generally positioned near an outer edge of the front portion 122 and may be generally rectangular in shape. Although the handholds 126 are described as substantially rectangular, the handholds 126 are not limited to a substantially rectangular shape and other shapes may be utilized, within the scope of the present disclosure. The back portion 124 may define a back opening 128 configured to receive the support member 110. The back opening 124 may be generally rectangular. Although the back opening 124 is described as generally rectangular, the back opening 124 is not limited to a substantially rectangular shape and other shapes may be utilized, within the scope of the present disclosure.

The base portion 130 is configured to facilitate moving the system 100 and to supplement the top platform 120 to facilitate performing tasks associated with stocking shelves and/or rotating stock. The base portion 130 may include a base platform 132. The base platform 132 may be constructed of, e.g., high density polyethylene and/or other appropriate materials, as will be understood by those skilled in the art. The base platform 132 may include a front portion 131 and a back portion 137. The front portion 131 may be substantially rectangular, with generally rounded corners. Although the front portion 131 is described as substantially rectangular, the front portion 131 is not limited to a substantially rectangular shape and other shapes may be utilized, within the scope of the present disclosure. For example, the base portion may be about 30 inches long by about 22 inches wide. The base portion 130 may include a first set 135 and/or a second set 137 of features positioned on a top surface 133 of the base platform 132. The first set 135 of features may be generally positioned on the front portion 131 of the base platform 132 and may be configured to hold items placed on the base platform 132. For example, the first set 135 of features may include at least one lip, rail and/or flange positioned adjacent an outer edge of the front portion 131 of the base platform 132, configured to hold a container and/or box, on the base platform 132. The first set 135 of features may be configured to hold a waste basket, step stool and/or other items that may be useful when stocking shelves and/or rotating stock. For example, the first set 135 of features may be configured to accommodate containers of up to about 16 inches by about 20 inches. The second set 137 of features may include one or more raised strips positioned on the top surface 133 of the front portion 131 of the base platform 132 a greater distance from the outer edge of the base platform 132 than the first set of features 135. The second set 137 of features is configured to hold a smaller container, a stool and/or to offset a larger container from the top surface 133 of the base platform 132. The base platform 132 may further define a base opening 133, generally positioned in the back portion 136 of the base platform 132. The base opening 133 is configured to receive the support member 110. The base opening 133 may be further configured to receive a container, e.g., a bin or a bucket. For example, the bin may be about 6 inches by about 8 inches by about 14 inches.

The base portion 130 may include a plurality of wheels 138 coupled to the base platform 132, e.g., to a bottom surface 139 of the base platform 132. For example, the wheels may have a diameter of about 4 inches. The wheels 138 may be coupled to the bottom surface 139, generally near each corner of the base platform 132. At least some of the wheels 138 may be configured to swivel, i.e., to rotate in a manner configured to facilitate turning the system 100. The wheels that are configured to swivel may include swivel locks configured to prevent the wheels from swiveling. At least some of the wheels 138 may further include “parking” brakes, configured to prevent movement of the system 100, e.g., once the system 100 has been positioned for loading and/or stocking shelves and/or rotating stock.

Turning to FIG. 1C, there is depicted a bottom view of the portable adjustable height platform system 100. As shown, the front edge 104 of the top platform 120 may extend over a front edge 108 of the base portion 130. This configuration may facilitate positioning the system 100 relative to a shelf configured to be stocked and/or restocked. In other words, the top platform 120 may contact the shelf while the base portion 130 may be a distance from a lower shelf.

The support member 110 is configured to support the top platform 120 and to guide generally vertical movement of the top platform 120. The support member 110 may have a substantially rectangular cross section, perpendicular to a long axis of the support member 110. Although the cross section of the support member 110 is described as substantially rectangular, the support member 110 is not limited to a substantially rectangular shape and other shapes may be utilized, within the scope of the present disclosure. The support member 110 may further include a channel 112 coupled to a back surface 113 of the support member 110. The support member 110 may include a plurality of openings 114 defined in a front surface 115 configured to receive a locking pin, as described herein. The support member 110 may be generally hollow. It is contemplated that, in some embodiments, the front surface 115 may include a feature configured to provide friction to aid in holding the top platform 120 at a user-selected height. The support member 110 is configured to couple the top platform 120 and the base portion 130. The support member 110 is further configured to support the top platform 120 at a plurality of positions between a minimum height and a maximum height. Height may be measured from a floor, i.e., a surface contacted by the wheels 138 and/or from the top surface 133 of the base platform 132. For example, the minimum height of the top platform may be about 22.75 inches above the floor or about 15 inches above the top surface 133 of the base platform 132 and the maximum height may be about 52.75 inches above the floor or about 45 inches above the top surface 133 of the base platform 132. Continuing with this example, the support member 110 is configured to allow the top platform to travel a distance of about 30 inches. In another example, a range of height of the top platform 120 above the floor may be between about 23.25 inches and about 53.25 inches (about 30 inches of travel). In this example, the height of the base platform 132 may be about 8.25 inches above the floor. FIG. 1B illustrates the top platform 120 in a lowered position and in a raised position.

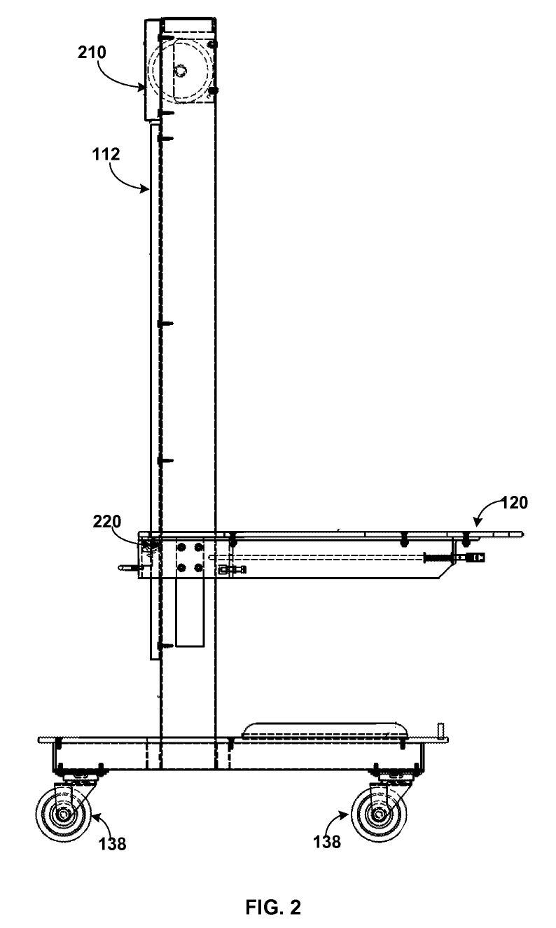

Turning to FIG. 2, there is illustrated a side view of the portable adjustable height platform system 100 of FIG. 1A. The height of the top platform 120 is configured to be adjusted when the top platform 120 is empty, i.e., is not supporting product, in a container and/or individual items. To facilitate adjusting the height of the top platform 120, the system 100 may include a counter balance mechanism 210. The counter balance mechanism 210 is configured to counter a weight associated with the top platform 120. The counter balance mechanism 210 is configured to present the top platform 120 in a neutral condition so that the top platform 120 does not rise or fall rapidly when fixing member(s) and/or a locking pin are disengaged from the support member 110, as described herein. In other words, the top platform 120 and counter balance mechanism 210 are configured such that the top platform 120 may be moved relatively easily, up and/or down. For example, the counter balance mechanism 210 may include a cable, a pulley and a torsion spring, e.g., “clock spring”.

The counter balance mechanism 210 may be mounted within and adjacent a top of the support member 110, i.e., above a maximum height of the top platform 120. The cable is configured to couple the counter balance mechanism 210 to the top platform 120. The cable may extend from the pulley into the channel 112 to a coupling 220, as described herein. The counter balance mechanism 210 is configured to provide a controlled spring force for the range of travel of the top platform 120. For example, the counter balance mechanism may provide a generally constant spring force for about 30 inches of travel of the top platform 120. In this manner, a user may raise or lower the top platform with a relatively small added force, as the counter balance mechanism is configured to counter the weight associated with the top platform 120.

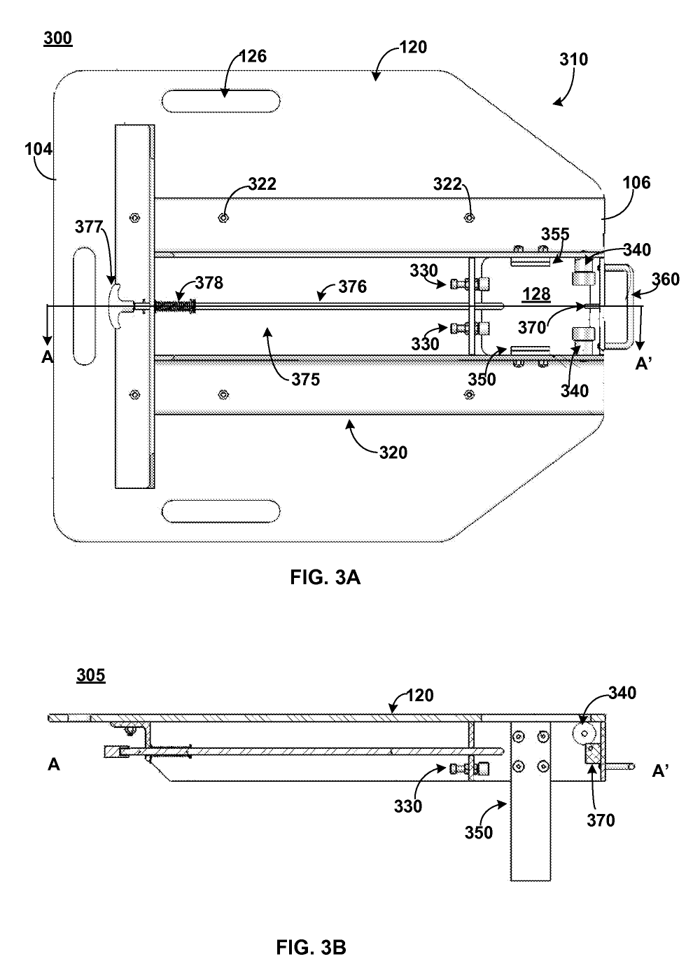

Turning to FIGS. 3A and 3B, there are illustrated a bottom view 300 and a side cross sectional view 350, respectively, of a top platform assembly 310. The top platform assembly 310 is configured to couple the top platform 120 to the support member 110, to facilitate adjusting the height of the top platform 120 and to fix the top platform 120 to the support member 110 at a user-selected height. The top platform assembly 310 may include the top platform 120, a top platform mounting member 320, at least one fixing member 330, at least one roller guide 340, a first and second roll support 350, 355, a top platform handle 360 and a counter balance coupling 370.

The top platform mounting member 320 may be coupled to a bottom surface 302 of the top platform 120 by a plurality of fasteners 322. The top platform mounting member 320 may extend from the front portion 122 of the top platform 120 to the back portion 124 of the top platform 120 and may be positioned adjacent the support member opening 128. The top platform mounting member 320 may extend a distance beneath the bottom surface 302 of the top platform 120. The at least one fixing member 330 may be coupled to the top platform mounting member 320. The fixing member(s) 330 may extend from the top platform mounting member 320 into the support member opening 128. The fixing member(s) 330 are configured to engage the support member 110 to hold the top platform 120 at a user-selected height. A position of the fixing member(s) 330 may be adjustable to ensure engagement with the support member 110 when the top platform 120 is substantially horizontal and disengagement when a front edge 104 of the top platform 120 is raised by a user (e.g., in order to adjust the height of the top platform 120), as described herein.

The at least one roller guide 340 is configured to facilitate movement of the top platform 120 relative to the support member 110. It is contemplated that, in some embodiments, the roller guide(s) 340 may be omitted, e.g., for cost savings. The roller guide(s) 340 may extend from the top platform assembly 310 into the support member opening 128. For example, when the front edge 104 of the top platform 120 is raised relative to a back edge 106 of the top platform 120, e.g., by holding down on handle 360 and lifting the front portion 122, the roller guide(s) 340 may act as pivot point(s) for the top platform 120 relative to the back surface 113 of the support member 110. As the front edge 104 is raised relative to the back edge 106, the fixing member(s) 330 may be moved in an arc relative to the pivot point(s) to disengage the support member 110. The height of the top platform 120 may then be adjusted to a desired height. When the desired height is reached, the front edge 104 may be lowered so that the top platform 120 is substantially horizontal and the fixing member(s) 330 are again engaged with the support member 110. The roller guide(s) 340 are further configured to facilitate movement of the top platform 120 relative to the support member 110. For example, as the top platform assembly 310 is moved up and/or down relative to the support member 110, the roller guide(s) are configured to roll with the movement of the top platform assembly 310

The first and second roll supports 350, 355 are configured to prevent the top platform 120 from “rolling”, i.e., to prevent the top platform 120 from rotating from side to side. The first and second roll supports 350, 355 are configured to engage the support member 110. The first and second roll supports 350, 355 may include an inner layer configured to slidably couple the first and second roll supports 350, 355 to the support member 110. The inner layer is configured to provide a relatively low friction contact between the first and second roll supports 350, 355 and the support member 110. Accordingly, the inner layer may include a plastic or other relatively low friction material known to those skilled in the art.

The top platform handle 360 is configured to facilitate adjusting the height of the top platform 120, as described herein. The top platform handle 360 is further configured to facilitate moving and positioning the system 100 relative to a supply of product and/or a shelf configured to receive the product.

The counter balance coupling 370 is configured to be coupled to the counter balance mechanism 210. For example, the counter balance coupling 370 may define an opening configured to receive a hook coupled to an end of the counter balance cable. The counter balance coupling may extend from the top platform assembly 310 into the support member opening 128, and may be aligned generally with a centerline of the channel 112. The counter balance cable may extend from the counter balance pulley into the channel 112 then to the counter balance coupling 370.

The top platform assembly 310 may further include a locking pin assembly 375 configured to provide a positive lock of the top platform 120 at a user-selected height. The locking pin assembly 375 may include a locking pin 376, a locking pin handle 377 and a spring 378. The locking pin assembly 375 may be coupled to the top platform mounting member 320. A first end of the locking pin 376 may be coupled to the locking pin handle 377. The locking pin handle 377 may be positioned below the front edge 104 of the top platform, and may be generally centered from side to side. A second end of the locking pin 376 may extend into the support member opening 128 and may be configured to align with a pin opening 114 defined by the support member 110. The spring 378 is configured to bias the locking pin 376 toward the support member 110, so that the locking pin 376 may extend into a pin opening 114 in the support member 110 to lock the top platform 120 at a height. When a user adjusts the height of the top platform 120, the locking pin 376 may be released by pulling the handle 377 to overcome the spring 378 force and remove the locking pin 376 from the pin opening 114. Once the locking pin 376 is removed from the pin opening 114, the front edge 104 of the top platform 120 may be raised to release the fixing member(s)330, and the top platform 120 height may be adjusted as described herein.

Accordingly, the top platform assembly 310 is configured to facilitate moving the top platform 120 to a user-selected height and fixing the top platform 120 at that height. The system 100 may further include a counter balance mechanism 210 configured to counter a weight associated with the top platform 120, e.g., the weight of the top platform assembly 310, so that minimal user effort may be used to move the top platform 120 up and/or down. The counter balance mechanism 210 is configured to present the top platform 120 in a neutral condition so that the top platform 120 does not rise or fall rapidly when the fixing member(s) 330 and/or locking pin 376 are disengaged from the support member 110. In this manner, the top platform 120 may be positioned by the user at a user-selected height and may then be loaded with a container of product and/or individual items to be stocked and/or restocked.

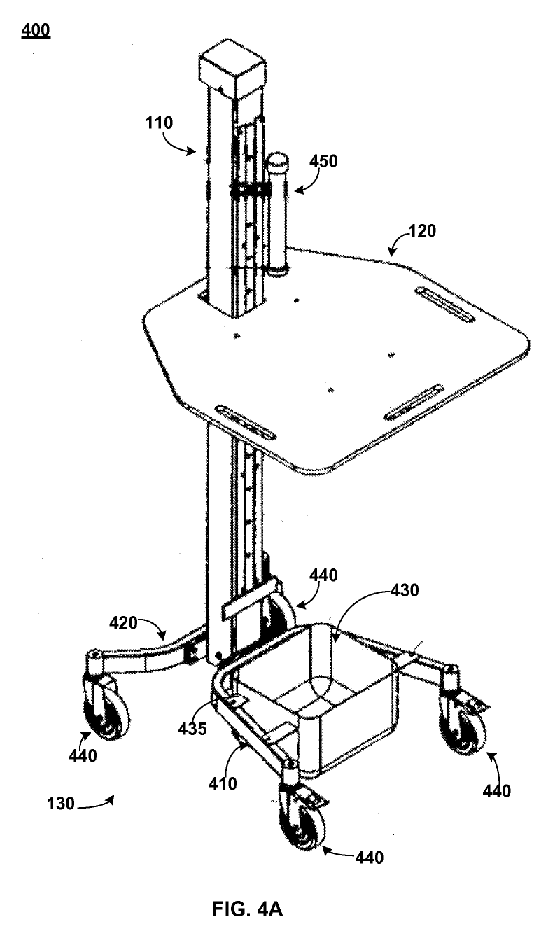

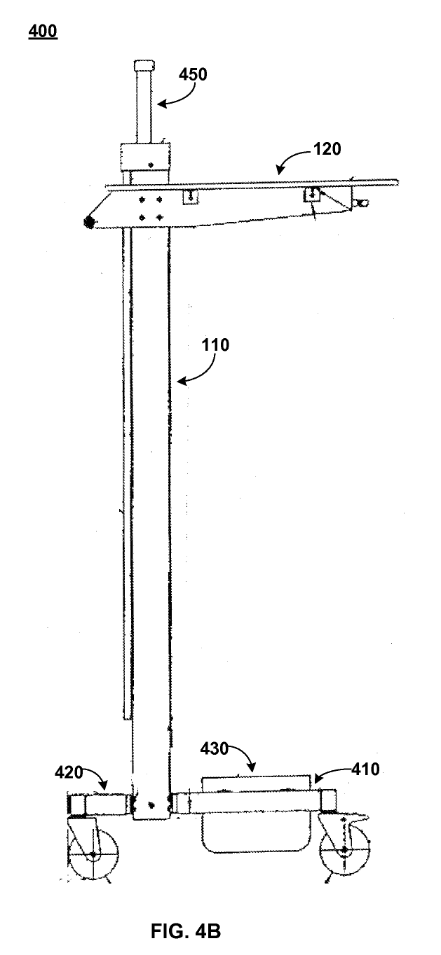

Turning to FIGS. 4A and 4B, there is illustrated another embodiment 400 of a portable adjustable height platform system consistent with the present disclosure. In this embodiment 400, the base portion 130 may include a front base bracket 410 and a back base bracket 420. The front base bracket 410 and back base bracket 420 may be coupled to the support member 110. The top platform 120 may be coupled to the support member 110 as described herein. The front base bracket 420 may be configured to receive a base bucket 430. The base bucket 430 may be coupled to the front base bracket 420 by a plurality of tabs 435. This embodiment 400 may include a plurality, e.g., four, wheels 440. Two of the wheels 440 may be coupled to the front base bracket 410 and two wheels may be coupled to the back base bracket 420. One or more of the wheels 440 may be configured to swivel and/or may include locking brakes, as described herein. This embodiment 400 may further include a paper towel holder 450.

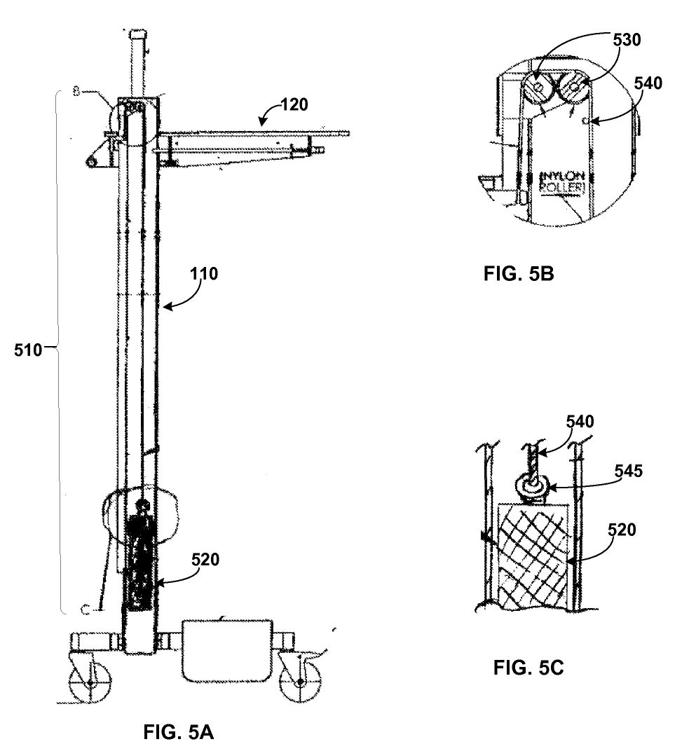

Turning to FIGS. 5A through 5C, there is depicted another embodiment of a counter balance system 510 consistent with the present disclosure. The counter balance system 510 may include a counter weight 520, a plurality of rollers 530 and a cable 540. The counter weight 520 may be coupled to the top platform 120 by the cable 540. For example, the cable 540 may be coupled to the counter weight 520 at a first end and to the top platform 120 at a second end. The cable 540 may be coupled to the counter weight 520 by a coupling 545. For example, the coupling 545 may be configured to couple to a loop in the cable 540 using, e.g., a clevis. The rollers 530 are configured to allow the cable 540 to move smoothly as the top platform 120 is raised and/or lowered, as described herein. In this embodiment, the counter weight 520, cable 540 and roller(s) 530 are configured to be contained within the support member 110.

Accordingly, a portable adjustable height platform system consistent with the present disclosure provides a portable adjustable height platform configured to facilitate stocking and/or restocking shelves and/or rotating stock in, e.g., a store such as a supermarket. The system may include an adjustable height top platform and a counter balance system so that the height of the top platform may be adjusted relatively easily. In this manner, the height of the top platform may be adjusted and the top platform may then be loaded with product to be stocked and/or restocked and/or rotated. The system may then be moved to the shelf and the user may stock and/or restock product from and/or to the top platform, without having to hold a container or a number of items while stocking and/or restocking.

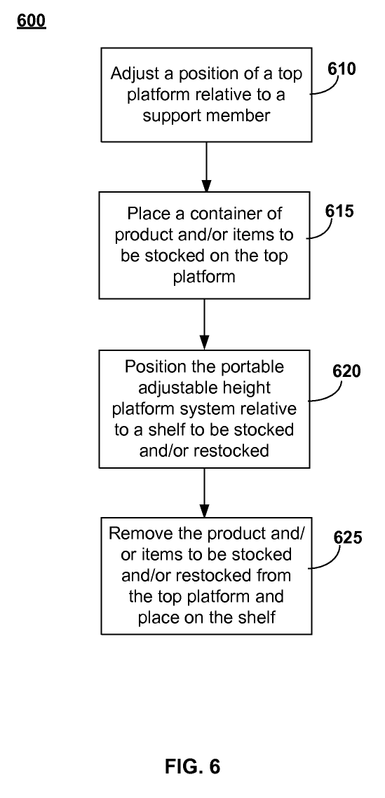

Referring to FIG. 6, there is illustrated a flow chart 600 for stocking and/or restocking shelves and/or rotating stock using a portable adjustable height platform consistent with the present disclosure. At operation 610, a position, i.e., height, of a top platform, e.g., top platform 120, may be adjusted relative to a support member, e.g., support member 110. In other words, the top platform may be positioned at a user-selected height. Operation 610 may include fixing the position of the top platform at the user-selected height. In some embodiments, operation 610 may further include locking the top platform at the user-selected height. At operation 615, a container of product and/or a plurality of items to be stocked and/or restocked and/or rotated may be placed on the top platform. For example, the container of product and/or individual items may be provided from a supply of product and/or individual items. At operation 620, the portable adjustable height platform system may be positioned relative to a shelf to be stocked and/or restocked and/or containing product to be rotated. Operation 620 may further include locking one or more wheels to prevent swiveling and/or other movement of the wheels and associated movement of the system. At operation 625, the product and/or items to be stocked and/or restocked may be removed from the top platform and placed on the shelf. If product is to be rotated, operation 625 may include removing older product from the shelf, placing the older product on the top platform, stocking the shelf with newer product and/or items and returning the older product to the shelf, e.g., in front of the newer product. The operations may then be repeated until the stocking and/or restocking is complete.

According to one aspect, there is disclosed a system for stocking shelves. The system may include a support member and a top platform coupled to the support member. The top platform is configured to receive at least one of a container of product and individual items to be at least one of stocked and restocked, wherein a height of the top platform is configured to be adjusted to a user-selected height and fixed at the user-selected height prior to receiving the at least one of the container of product and the individual items. The system may include a base portion coupled to the support member, wherein the base portion is configured to facilitate positioning the system relative to a shelf to be at least one of stocked or restocked.

According to another aspect, there is provided a system for stocking shelves. The system may include a support member and a top platform coupled to the support member. The top platform is configured to receive at least one of a container of product or individual items to be at least one of stocked or restocked, wherein a height of the top platform is configured to be adjusted to a user-selected height and fixed at the user-selected height prior to receiving the at least one of the container of product or the individual items. The system may include a base portion coupled to the support member, wherein the base portion comprises a base platform and the base portion is configured to facilitate positioning the system relative to a shelf to be at least one of stocked or restocked, wherein the base portion further comprises a plurality of wheels configured to facilitate moving the system from a location adjacent a supply of the at least one of the container of product or individual items to the shelf to be at least one of stocked or restocked. The system may further include at least one fixing member configured to hold the top platform at the user-selected height when the top platform is substantially horizontal and to release the top platform when a front edge of the top platform is raised relative to a back edge of the top platform; and a counter balance coupled to the top platform and the support member, wherein the counter balance is configured to counter a weight associated with the top platform.

According to another aspect, there is provided a method for a stocking shelf. The method may include adjusting a height of a top platform of a portable adjustable height platform system relative to a support member of the portable adjustable height platform system; placing at least one of a container of product to be stocked or a plurality of individual items to be stocked on the top platform; positioning the portable adjustable height platform system relative to a shelf to be at least one of stocked or restocked; and removing the at least one of the product or the individual items from the top platform and placing the at least one of the product or the individual items on the shelf.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible.

What is claimed is:

1. A system for stocking shelves comprising:
a support member;
a top platform coupled to the support member, the top platform configured to receive at least one of a container of product and individual items to be at least one of stocked and restocked, wherein a height of the top platform is configured to be adjusted to a user-selected height and fixed at the user-selected height prior to receiving the at least one of the container of product and the individual items; and
a base portion coupled to the support member, wherein the base portion is configured to facilitate positioning the system relative to a shelf to be at least one of stocked or restocked.

2. A system according to claim 1, further comprising a counter balance coupled to the top platform and the support member, wherein the counter balance is configured to counter a weight associated with the top platform.

3. A system according to claim 1, wherein the base portion comprises a plurality of wheels configured to facilitate moving the system from a location adjacent a supply of the at least one of the container of product and individual items to the shelf to be at least one of stocked or restocked.

4. A system according to claim 3, wherein the wheels are configured to swivel and at least one wheel comprises a swivel lock configured to prevent the wheel from swiveling and at least one wheel comprises a wheel lock configured to prevent the system from moving.

5. A system according to claim 1, wherein the base portion comprises a base platform.

6. A system according to claim 1, wherein the base portion comprises a bucket.

7. A system according to claim 5, wherein the base platform comprises a first set of features configured to hold a container on the base platform.

8. A system according to claim 1, further comprising at least one fixing member configured to hold the top platform at the user-selected height when the top platform is substantially horizontal and to release the top platform when a front edge of the top platform is raised relative to a back edge of the top platform.

9. A system according to claim 1, further comprising a locking pin configured to lock the top platform at the user-selected height.

10. A system according to claim 2, wherein the counter balance comprises a pulley, a cable and a torsion spring configured to exert a constant force on the top platform and the support member comprises a channel configured to receive the cable.

11. A system according to claim 2, wherein the support member is hollow, the counter balance comprises a counter weight, a plurality of rollers and a cable and the counter weight and the cable are contained within the support member.

12. A system for stocking shelves comprising:
a support member;
a top platform coupled to the support member, the top platform configured to receive at least one of a container of product or individual items to be at least one of stocked or restocked,
wherein a height of the top platform is configured to be adjusted to a user-selected height and fixed at the user-selected height prior to receiving the at least one of the container of product or the individual items;
a base portion coupled to the support member, wherein the base portion comprises a base platform and the base portion is configured to facilitate positioning the system relative to a shelf to be at least one of stocked or restocked, wherein the base portion further comprises a plurality of wheels configured to facilitate moving the system from a location adjacent a supply of the at least one of the container of product or individual items to the shelf to be at least one of stocked or restocked;
at least one fixing member configured to hold the top platform at the user-selected height when the top platform is substantially horizontal and to release the top platform when a front edge of the top platform is raised relative to a back edge of the top platform; and
a counter balance coupled to the top platform and the support member, wherein the counter balance is configured to counter a weight associated with the top platform.

13. A method for stocking a shelf, said method comprising:
adjusting a height of a top platform of a portable adjustable height platform system relative to a support member of the portable adjustable height platform system;
placing at least one of a container of product to be stocked or a plurality of individual items to be stocked on the top platform;
positioning the portable adjustable height platform system relative to a shelf to be at least one of stocked or restocked; and
removing the at least one of the product or the individual items from the top platform and placing the at least one of the product or the individual items on the shelf.

14. A method according to claim 13, wherein adjusting the height of the top platform comprises:
raising a front edge of the top platform relative to a back edge of the top platform to disengage at least one fixing member from the support member,
raising or lowering the top platform to a user-selected height, and
lowering the front edge of the top platform relative to the back edge of the top platform to engage the at least one fixing member with the support member.

15. A method according to claim 13, wherein the portable adjustable height platform system further comprises a counter balance mechanism coupled to the top platform and the support member, the counter balance mechanism configured to counter a weight associated with the top platform.

16. A method according to claim 13, wherein adjusting the height of the top platform further comprises releasing a locking pin configured to lock the top platform at the user-selected height.

17. A method according to claim 13, further comprising applying at least one of a swivel lock or a locking brake to at least one of a plurality of wheels to prevent the portable adjustable height platform system from moving after it has been positioned relative to the shelf.

18. A method according to claim 13, wherein the portable adjustable height platform system comprises a base portion.

19. A method according to claim 18, wherein the base portion comprises a first set of features configured to hold a container on the base platform.

20. A method according to claim 18, wherein the base portion comprises a bucket.
